(19) United States
(12) Patent Application Publication
(10) Pub. No.: US 2022/0309503 A1
(43) Pub. Date: Sep. 29, 2022

(54) SECURE AND SEAMLESS INTEGRATION OF TRUSTLESS BLOCKCHAIN MERCHANT CONNECTOR

(71) Applicant: Hypernet Labs, Inc., Redwood City, CA (US)

(72) Inventors: Charles William Sibbach, Paso Robles, CA (US); Todd Allen Chapman, Standord, CA (US)

(21) Appl. No.: 17/706,499

(22) Filed: Mar. 28, 2022

Related U.S. Application Data
(60) Provisional application No. 63/166,925, filed on Mar. 26, 2021.

(51) Int. Cl. G06Q 20/40; G06Q 20/38; G06Q 20/36

(52) U.S. Cl. CPC G06Q 20/401; G06Q 20/3825; G06Q 20/36; G06Q 2220/00

(57) ABSTRACT

A request processing system uses Iframes and in particular, nested Iframes to provide an isolated environment where various forms of user requests can be processed for different clients within one outer Iframe that can be re-instantiated across various client web applications. A user request can include a payment made using a cryptocurrency against the user's blockchain wallet. The request processing system can employ persistent authorization storage to allow users to authenticate themselves for future requests without further involving themselves (e.g., exposing their private key to authenticate themselves). The request processing system utilizes nested Iframes to promote security among simultaneously processed requests. Each nested Iframe can perform operations that are isolated from other nested Iframes. Thus, different merchants that run on respective nested Iframes are prevented from communicating to one another, preventing a given merchant from spoofing requests against some other merchant's account for that user.

### CROSS REFERENCE TO RELATED APPLICATIONS

This application claims the benefit of U.S. Provisional Application No. 63/166,925, filed Mar. 26, 2021, which is incorporated by reference in its entirety.

### TECHNICAL FIELD

The disclosure generally relates to the field of blockchain technology, and more particularly relates to implementing a blockchain client connector that processes blockchain transactions without requiring a central trust authority.

### BACKGROUND

Sensitive information is frequently exposed during routine operations performed online. For example, for transactions fulfilled using conventional payment processors, sensitive user identification and payment information can be exposed to make and authenticate a payment. Even conventional blockchain payment processors, despite lacking the conventional payment processor as an intermediary between a merchant and a customer, can still expose customers to security risks when they ask customers to re-authenticate themselves each time the customer accesses the conventional blockchain payment processor. Not only does this lead to security risks, but also demands a large amount of computation power for authenticating the customer. The security risks are further amplified when the conventional blockchain payment processor is executed on a typical Internet browsing environment that has malicious actors targeting users as they make transactions online.

### SUMMARY

Systems and methods are disclosed herein for request fulfillment that improves security and reduces processing demands. A request processing system uses Iframes and in particular, nested Iframes to provide an isolated environment where various forms of user requests can be processed for different clients within one outer Iframe that can be re-instantiated across various client web applications. A user request can include a payment made using a cryptocurrency against the user's blockchain wallet. The various forms of user requests can include processing multiple requests for the same merchant or various merchants simultaneously (e.g., at at least one common time).

The request processing system employs persistent authorization storage to allow users to authenticate themselves with decreased frequency relative to conventional systems. For example, a user is asked to authenticate themselves using their cryptographic signature and given an option to store the artifact of their authentication (e.g., a code packet used for processing transactions that is signed using their private key) for a period of time or until a number of requests are processed. This reduces the number of times users must re-authenticate themselves and expose their private keys, increasing security relative to conventional payment processors.

Furthermore, the request processing system utilizes nested Iframes to promote security among simultaneously processed requests. Each nested Iframe can perform operations that are isolated from other nested Iframes. Thus, different merchants that run on respective nested Iframes are prevented from communicating to one another, preventing a given merchant from spoofing requests against some other merchant's account for that user. Additionally, each nested Iframe may contain a code packet that has smaller memory and processing footprints than conventional systems that may overhaul a client's backend to ensure compatibility with a payment processor that attempts to enable simultaneously processing of transactions with different clients.

In one example embodiment, the requesting processing system determines that a user has navigated to a merchant web application and selected to use a blockchain payment tool. The system instantiates a nested Iframe for the merchant. The nested Iframe may be instantiated among multiple Iframes for different merchants. The Iframes may be instantiated within an external Iframe, which is also referred to herein as an outer Iframe. The system requests a code packet from a backend hosting service of the merchant. The system receives the code packet and a signature of the merchant. The system verifies an authenticity of the code packet by comparing the signature of the merchant against a decentralized registry of merchant signatures. After authenticating the code packet, the system loads the authenticated code packet into the nested Iframe. To authenticate the user, the system obtains a signature from the user. To reduce the user's exposure to security risks, system may obtain this signature in connection with a persistent authorization for the merchant. The system may then persistently store the signature of the user in connection with information of the merchant (e.g., a URL of the merchant). By employing persistent storage, the system can enable payment processing using the persistently stored signature of the user during future interactions between the user and the merchant web application.

In some embodiments, the system determines that the user selects to use a blockchain payment tool by determining that the user has selected an option, from various payment tool options, corresponding to the blockchain payment tool. The decentralized registry of merchant signatures can be curated using a decentralized governance mechanism. The decentralized governance mechanism can be a blockchain mechanism that ensures the merchant signature cannot be tampered with. The persistent authorization may enable a cryptocurrency transaction to ensue in partitions over time until the cryptocurrency transaction is complete. Multiple nested Iframes may be configured to process payments for multiple merchants simultaneously. A nested Iframe can be instantiated within an insecure browser environment. However, code (e.g., client code packets) operated within the nested Iframe can be secure. The decentralized registry can include, for each merchant registered within the decentralized registry, a data structure that maps a merchant uniform resource locator (URL) to a blockchain wallet address of the merchant and a cryptographic signature of a code packet corresponding to the merchant. The system can persistently store the signature of the user in connection with information of the merchant by persistently storing the merchant URL and the blockchain wallet address of the merchant for retrieval during future web session. Persistently storing the signature of the user in connection with the information of the merchant can maintain authorization of the merchant to debit cryptocurrency from the user without further authorization.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram of a system environment in which a request processing system operates, in accordance with at least one embodiment.

FIG. 2 depicts a system environment for implementing a blockchain client connector using a request processing system, in accordance with one embodiment.

FIGS. 3-5 form an interaction diagram showing interactions between various entities for processing requests using persistent authentication, in accordance with one embodiment.

FIG. 6 is an interaction diagram showing interactions between various entities for processing requests across multiple devices using persistent authentication, in accordance with one embodiment.

FIG. 7 is an interaction diagram showing interactions between various entities for processing requests in parallel with a single client, in accordance with one embodiment.

FIG. 8 is an interaction diagram showing interactions between various entities for preventing malicious actors from making fraudulent requests against an end user's account (e.g., blockchain wallet), in accordance with one embodiment.

FIG. 9 is a flowchart depicting a process for instantiating a code packet used to fulfill a user's request and persistently store data authenticating the user for future requests, in accordance with one embodiment.

FIG. 10 is a block diagram illustrating components of an example machine able to read instructions from a machine-readable medium and execute them in a processor.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Request Processing System Architecture

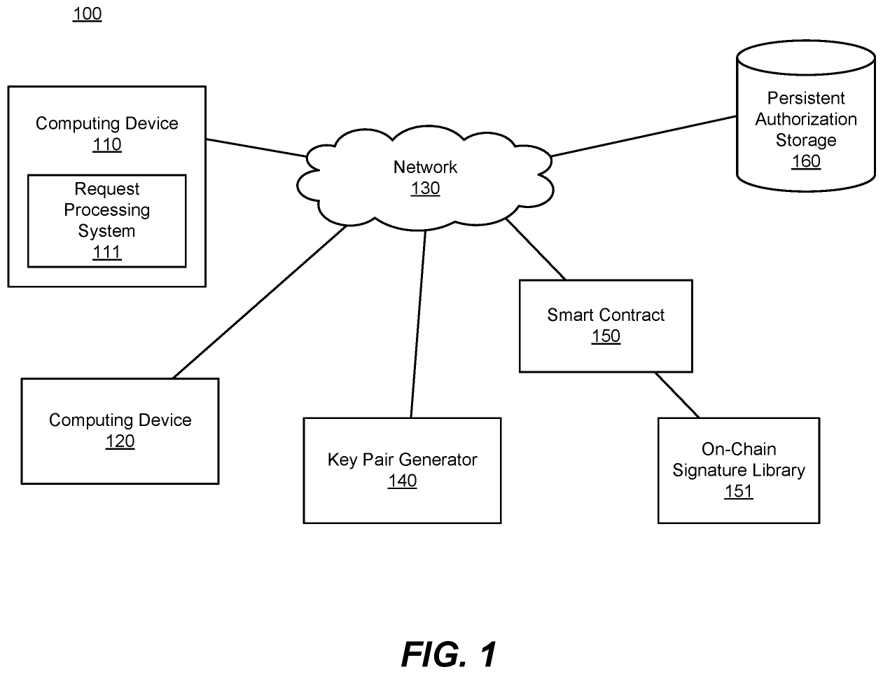

FIG. 1 is a block diagram of system environment 100 in which request processing system 111 operates, in accordance with at least one embodiment. System environment 100 includes computing device 110, an instance of request processing system 111 executing on computing device 110, computing device 112, network 130, key pair generator 140, smart contract 150, on-chain signature library 151, and persistent authorization storage 160. System environment 100 may have alternative configurations than shown in FIG. 1, including for example different, fewer, or additional components.

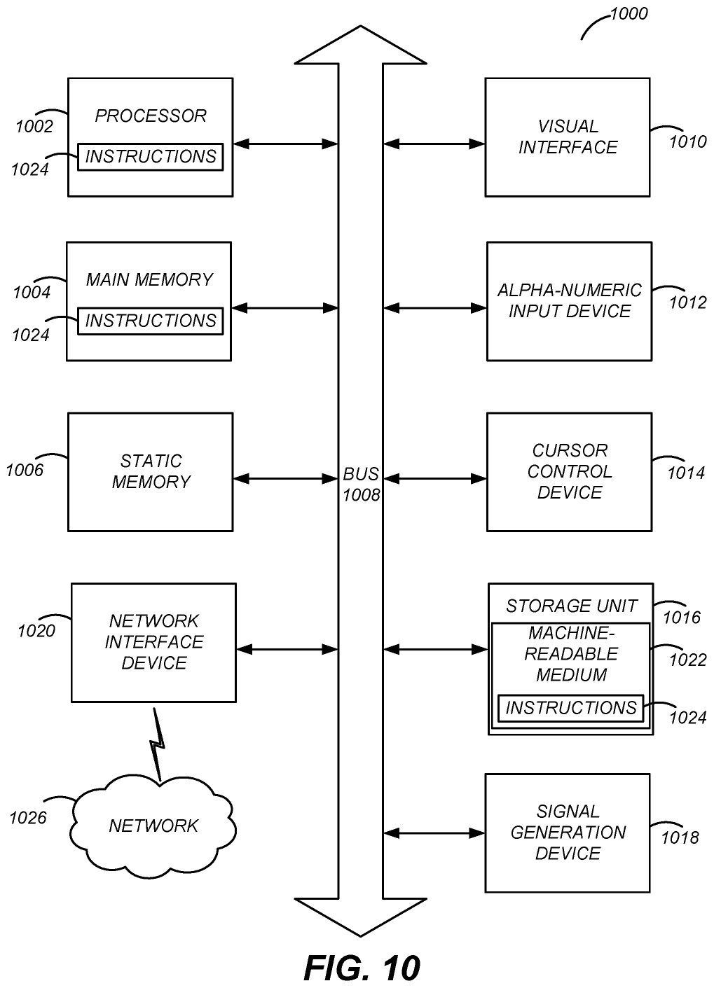

Computing devices 110 and 120 are examples of computing devices for users to process requests using persistent authorization, in parallel, or across multiple devices as enabled by request processing system 111. For example, request processing system 111 may display a prompt at computing device 110 asking for confirmation to persistently store a user's authentication information (e.g., a code packet used for processing blockchain transactions that is signed by the user's private key, which is also referred to herein as an “authorization signature”). Request processing system 111 may be locally installed at devices 110 or 120 or remotely accessible at a remote server through network 130. In some embodiments, the computing device is a computer system such as a desktop or a laptop computer. An example of a computer system is shown in FIG. 10. Alternatively, the computing device may be a device having computer functionality, such as a personal digital assistant (PDA), a mobile telephone, a smartphone, or another suitable device. Computing devices 110 and 120 are configured to communicate with one another, key pair generator 140, smart contract 150, on-chain signature library 151, and persistent authorization storage 160 via network 130. A computing device may use, for example, a native application executed by the computing device and which provides functionality of system 111. A computing device may access an external instantiation of system 111 (e.g., executing on a remote server) through an application programming interface (API) running on a native operating system of the computing device, such as IOS® or ANDROID™. A computing device may use an Internet browser to access functionalities of system 111.

Request processing system 111 validates requests made via blockchain (e.g., blockchain transactions) to a client's web application. In a context of merchant transactions, system 111 may allow users and merchants to complete transactions in the absence of a third payment processor (e.g., credit card payment processors). A user may initiate a request at a client's web application, or “web app,” which may be a software infrastructure for enabling requests (e.g., requesting payment transactions for an online merchant). Online merchants can use system 111 to process payments via a blockchain in exchange for goods or services. The merchant's web app may be loaded into a user's browser context.

System 111 may include a set of software modules operating within an Internet browser context. The browser context can execute when a user opens an Internet browser such as GOOGLE CHROME™ or MOZILLA FIREFOX®. The software modules of system 111 can include executable instructions for generating a user interface or instantiating nested Iframes. System 111 instantiates nested Iframes that enable a user to fulfill requests with various clients in parallel. The requests can be performed substantially simultaneously, whereby the requests are processed by respective nested Iframes at at least one common time. A user may load a client web app by visiting a client URL that is utilizing a protocol of request processing system 111 as a request processor. For example, an online merchant's customer can use a merchant's website via the merchant URL, where the merchant's payment transactions are facilitated by request processing system 111 as the merchant's payment processor.

In some embodiments, a client web app may instantiate request processing system 111 as a code packet. For example, system 111 is loaded via a node package manager (NPM) package that is a JavaScript or typescript compatible module. In one embodiment, a client's JavaScript code for the client's web app may include an NPM package dependency corresponding to system 111. Thus, when a client builds a front end interface and serves the interface to the user, part of the dependency served to the user is an instantiation of system 111.

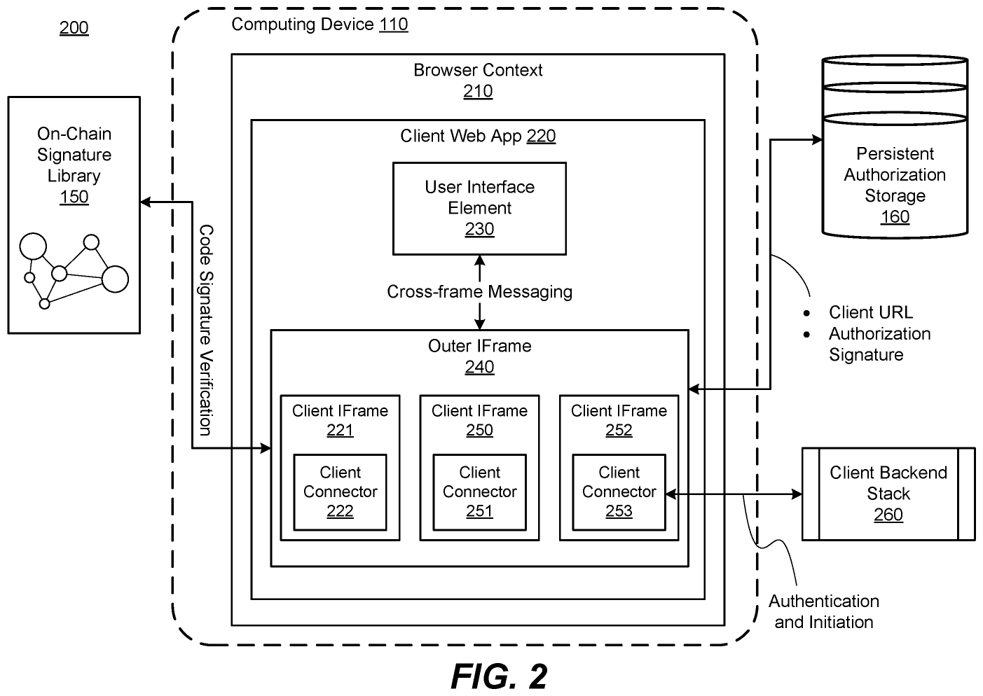

Request processing system 111 instantiates one or more nested Iframes. System 111 may instantiate an external Iframe that can perform operations in a secured fashion due to nested Iframes, each nested Iframe isolated from one another. A browser may be a hostile environment having various processes executing in the environment and malicious actors that try to spy on user activities. System 111 increases security by leveraging Iframes that prevent hostile processes from unauthorized accesses of a computing device's memory and issuing commands on code packets without authorization. In at least this way, a nested Iframe may be instantiated within an insecure browser environment, but code operated within the nested Iframe is secure. In addition to software components loaded and executed onto a browser environment, system 111 may include a decentralized network storing data for authenticating clients or users (e.g., smart contract 150, on-chain signature library 151, or persistent authorization storage 160). Components and operations of request processing system 111 are further described in the description of FIG. 2.

Network 130 communicatively couples computing devices 110 and 120, key pair generator 140, smart contract 150, on-chain signature library 151, and persistent authorization storage 160. In some embodiments, network 130 includes any combination of local area and/or wide area networks, using wired and/or wireless communication systems. Network 130 may use standard communications technologies and/or protocols. For example, network 130 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of network 130 may be encrypted using any suitable technique or techniques.

Key pair generator 140 is a device capable of generating key pairs or high quality key pairs. Key pair generator 140 may use an entropy pool (e.g., hardware activity) within a computer to serve as a pseudorandom value generator for a key. For high quality keys, each key in a high quality key pair may have a high level of entropy. For example, key pair generator 140 may generate a pair of keys using physical phenomena that are fundamentally random, such as those from certain quantum effects (e.g., nuclear decay) or physical phenomena (e.g., weather). In some embodiments, key pair generator 140 may be a component of request processing system 111 and locally stored and executed by a computing device. In circumstances where key pair generator 140 may need specialized components to generate high entropy key values, key pair generator 140 may be executed on a specialized device that is separate from computing devices 110 or 120 that a user utilizes for processing requests via blockchain (e.g., payments or other transactions using blockchain).

Smart contract 150 enables request processing system 111 to authenticate a client. In some embodiments, smart contract 150 receives a client identifier (e.g., a client uniform resource locator (URL)) and returns client data. Client data may include a client's blockchain wallet address, a cryptographic signature of the client (e.g., a code packet signed using a client's private key of the key pair generated by generator 140), or any suitable information identifying the client. Smart contract 150 may access client data stored on on-chain signature library 151. For example, smart contract 150 queries library 151 using a client URL and accesses a tuple including a client's blockchain wallet address and a cryptographic signature of a code packet of the client, where the library 151 stores the tuple mapped to the client URL. Smart contract 150 can include executable instructions (e.g., a software program) stored on a decentralized system (e.g., a blockchain) that is communicatively coupled to system environment 100 via network 130.

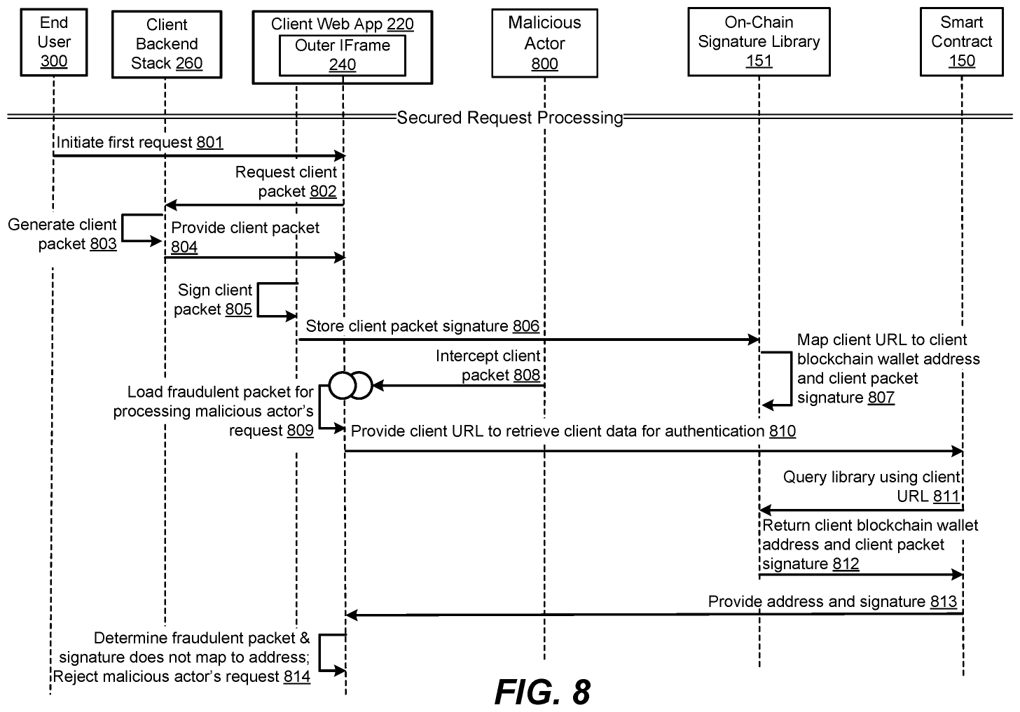

On-chain signature library 151 stores client data to enable request processing system 111 to authenticate a client. Library 151 may store client data for various clients. For example, library 151 is a curated registry of client connector signatures stored on-chain. Library 151 may be a decentralized registry of client signatures that is curated using a decentralized governance mechanism (e.g., a blockchain mechanism that ensures client signatures cannot be tampered with). Because library 151 stores client data on-chain, the stored data is difficult to spoof. Library 151 maps a client identifier (e.g., client URL) to data about the client (e.g., a tuple including a client's blockchain wallet address and a cryptographic signature of the client connector code packet). Library 151 may be part of a blockchain (e.g., the ETHEREUM® blockchain). Library 151 may be a collision-resistant signature library. Because library 151 may be an on-chain, collision-resistant signature library, library 151 enables system 111 to verify a client's authenticity. Malicious actors who may intercept an authenticated client connector may be prevented by system 111 from pushing and pulling requests (e.g., blockchain transactions) after leveraging the client data stored on library 151 to verify the malicious actor is not truly the client. An example of fraud prevention is further described in the description of FIG. 8.

Persistent authorization storage 160 stores information to authorize a user over a period of time or a number of requests. By leveraging storage 160, request processing system 111 can reduce a user's need to reauthenticate their identity to fulfill a request. This reduction provides both convenience and security to the user. By reducing the number of times as user authenticates themselves to system 111, the user is also reducing a number of times they are exposing sensitive information (e.g., a user's private keypair) that is needed to authenticate the user's identity. In one example, a user authorizes system 111 to store an object signed using the user's private key and use their signature to authorize the user for future requests until a particular condition is met (e.g., until the next ten requests are fulfilled or for a twenty four-hour duration).

FIG. 2 depicts system environment 200 for implementing a blockchain client connector using a request processing system, in accordance with one embodiment. Environment 200 can be executed using an Internet browser (e.g., browser context 210) operating on computing device 110. The request processing system may include user interface element 230, outer Iframe 240, client Iframes 221, 250, and 252, client connectors 222, 251, and 253, on-chain signature library 150, and persistent authorization storage 160. Although not depicted, the request processing system may also include a smart contract on the same blockchain as library 150.

Browser context 210 can execute when a user opens a web browser. Client web app 220 is within browser context 210. Client web app 220 may be loaded responsive to a user visiting a website (e.g., via a client URL) that is utilizing a request processing system's protocol to fulfill their users' requests (e.g., a merchant using the protocol as their payment processor). A client may load their client web app 220 in any number of ways. In one embodiment, the client uses a code packet (e.g., a JavaScript or typescript compatible module) that may be installed with a package manager (e.g., an NPM package manager). In one embodiment, a client can use an NPM package corresponding to the request processing system in the client's JavaScript code for web application 220. A merchant can thus build a front end interface and serve the interface to the user with the request processing system as part of a front end dependency.

Outer Iframe 240 can be an Iframe that performs operations in an isolated fashion and results in blockchain request fulfillment or transaction processing as described herein. Client web app 220 may communicate through a cross-frame messaging connection with a master process running within outer Iframe 240. The messaging, by the request processing system, can instruct client web app 220 to authenticate the user's account with the client's backend stack 260 (e.g., a backend server process). Client web app 220 may contain, as part of its runtime dependencies, outer Iframe 240 instance. Outer Iframe 240 may include one or more client Iframes 221, 250, and 252. Thus, request processing system includes a nested Iframe structure. The request processing system disclosed herein leverages the isolation provided by Iframes, which provide multi-layer processing running in a browser.

The request fulfillment described herein can be decentralized, and thus, leverage isolation provided by the Iframes to improve security. Security in this manner can be achieved because a browser is a hostile environment, where other processes are executed and malicious actors may be trying to snoop on user activities. An Iframe prevents hostile processes from snooping on memory and issuing commands on code packets where these processes should not be.

Outer Iframe 240 forms an outer virtualization shell that can execute an NPM module. In an ice tray type fashion, client connectors 222, 251, and 253 are each within respective, dedicated nested client Iframes 221, 250, and 252. Client Iframes 221, 250, and 252 can be fulfilling requests (e.g., processing payments) for multiple clients (e.g., merchants) substantially simultaneously (e.g., at at least one common time). In response to a user visiting one client website and providing approval to the request processing system that a client connector can be used to make fulfill requests with the client (e.g., make payments) with a user's account (e.g., user's blockchain wallet), the user has authorized a client connector code packet to run in outer Iframe 240. Furthermore, the user has authorized a client connector to receive and make calls to that specific client's request fulfillment system (e.g., a merchant's invoicing system to process payments on behalf of the invoicing system).

In some embodiments, after a user authorizes a client connector to fulfill a request (e.g., to make a payment), the request may not yet be fulfilled. For example, the user goes to a second website and approves a transaction for a second merchant, while still running a first merchant connector. In response to the first merchant continuing to bill the user for the transaction, the request processing system enables a merchant connector authorized by the user to continue passively processing the payment in the user's account against the website the user has already left. In response to receiving a notification that the user has authorized the second merchant to process payments, the request processing system may enable parallel processing of payment requests for both merchants in the user's browser. To fulfill the requests in parallel, the system may use client connectors that are both authenticated (e.g., client and user signatures are verified by the request processing system).

Client connectors 222, 251, and 253 may run in their own isolated virtual environments. Client Iframes 221, 250, and 252 surrounding the client connectors may prevent unknown attack vectors where there are multiple clients that are approved to be fulfilling requests using the user's blockchain account (e.g., making payment transactions against the blockchain account). Moreover, the request processing system may prevent a given client from spoofing requests against another client's connector for that user, because the nested Iframes prevent client connector to client connector communications using the nested and isolated Iframes. Yet further, the larger outer Iframe 240 instance can prevent that spoofing in requests against even an authorized client from external parties.

Based on the cross-frame messaging, the outer Iframe 240 instantiates the client Iframes and corresponding client connectors that will contain the client connector code. The client connector code may be provided to the outer Iframe 240 via the browsing session's client URL (e.g., accessing client backend stack 260 via the client URL). Additionally, outer Iframe 240 can load previously authorized client connectors from persistent authorization storage 160 to process pending requests (e.g., at at least a common time or substantially simultaneously) from other clients that the user has accounts with.

This can be advantageous relative to conventional systems, such as a traditionally architected payment service provider, where merchants must build an invoicing system with API calls to a centralized service. These API calls can be emitted to a third party online transaction service to pull money from user's account or initiate push payment. However, because there lacks a centralized service in blockchain architecture, there is no central authority from which to issue these push and pull commands. The client connectors may provide secure push and pull functionality for fulfilling payments with merchants.

Outer Iframe 240 requests the client connector code packet (e.g., using the client URL) from client backend stack 260. Client backend stack 260 can send the client connector code packet back to a client Iframe instance. Advantageously, these code packets can be small and use minimal resources for a client to integrate with an existing nested Iframe structure. This is distinguished from conventional payment processors, where a massive overhaul of a merchant's backend is at times undertaken to ensure compatibility.

The request processing system injects a signed client code packet into a user's browser (e.g., into nested Iframes). In some embodiments, the code packet can serve as a virtual payment processor and issue push and pull payments. The user can approve a client connector to make pull and push requests against their blockchain wallet, and the request processing system processes payments for a merchant in browser context 210. However, a client connector within a browser is inherently insecure due to the browser environment's execution of various processes and accessibility to malicious actors. Without the fraud prevention techniques employed by the request processing system described herein, the client connectors could be vulnerable to redirection attacks where a user's browser may think the browser is loading an authorized client's code packet, but in fact, an authentic client connector was intercepted and the client code packet being processed is fraudulent and being used to make illicit push and pull requests from a user's account. The fraud prevention techniques employed by the request processing system follow the fundamental tenet of decentralization because the system processes blockchain transactions. The request processing system employs a code packet signature verification using an on-chain smart contract and signature library.

Outer Iframe 240 is communicatively coupled to on-chain signature library 150 to perform packet code signature verification. Outer Iframe 240 can confirm the authenticity of a client connector code packet that has been signed using a client's private key by checking the signature against a curated registry of signatures signed using the client's private key that are stored on-chain in library 150, which is difficult to spoof because library 150 is stored on-chain. On-chain signature library 150 maps a client URL to a data about the client (e.g., tuple including the client's blockchain wallet address and a cryptographic signature of the client connector code packet, though any other information may be included or excluded). Outer Iframe 240 sends to an on-chain smart contract (e.g., smart contract 150) the client URL. The smart contract then return, for example, the tuple. Outer Iframe 240 can use the returned tuple's client signature to verify that the client connector code packet is authentic by running it through a signature verification algorithm. In one example of a signature verification algorithm, outer Iframe 240 verifies authenticity if a combination of the code packet and the tuple's client signature map to the tuple's client blockchain address. If the mapping does not match the client blockchain wallet address, the client connector code packet is rejected, and the request processing system can prevent requests from being fulfilled using that code packet (e.g., prevent payments from being pushed and pulled using the code packet).

In some embodiments, a client loads an outer Iframe into their client web app and programs a client connector that performs a desired function (e.g., using NPM packets). The client can cryptographically sign the client connector with the blockchain private key associated with the client's account on the blockchain (e.g., a SHA-256 hash algorithm). The request processing system stores the signature on signature library 150. Once the signature is stored, the signature cannot be spoofed because the signature library is a decentralized system. In at least this way, the system verifies a client's authenticity against an on-chain collision-resistant signature library.

In response to determining that the client's code packet verification is successful, the request processing system obtains an authorization signature from the user. The authorization signature may be a user's cryptographic signature of the client-signed code packet (a signature of a signature). The request processing system can prompt the user (e.g., via user interface element 230) to cryptographically sign the client connector code packet that has been signed by a client's private key. The request processing system may allow a client connector to fulfill requests (e.g., make pull and push payment requests) against the user's on-chain account (e.g., blockchain wallet) after determining that the authorization signature is valid. In an embodiment, the request processing system may use user interface element 230 to generate a UI prompt for the user to provide a user input indicating that the user approves or disapproves of their authorization signature being persistently stored in persistent authorization storage 160. The agreement may authorize a client to fulfill requests until such a time that the user revokes authorization. In some embodiments, the system may use UI element 230 to provide user toggles for specifying a duration of time during which their authorization signature may be persistently stored or a number of requests that can be fulfilled until their authorization signature is removed from persistent storage.

The request processing system can store a tuple including an authorization signature and a client URL in persistent authorization storage 160 and index the tuple using a user's blockchain wallet address. The request processing system can use this indexing to authenticate the user in future web sessions to avoid the need for repeated manual authorization of both the client and user when a user makes a request to the client. Persistent storage 160 may be centralized or decentralized. In some embodiments, the request processing system can load authenticated client connectors using the information stored in persistent storage 160. The user can thus initiate new requests or continue to process pending transactions without reauthentication and exposing their private key. When a user logs in on a new device or after a user restarts their machine, a default mapping may be used to find the tuple stored in persistent storage 160. For example, the address of the tuple may be mapped with a hash value of the user's blockchain wallet.

Conventional blockchain payment processors can require repetitious re-authentications each time that they are accessed, which requires a large amount of computation power and leads to security risks. There can be a large number of operations in authentication. Additionally, requiring a user to continually expose their private key to a potentially hostile browser environment produces security risks. Compute power and efficiency is improved, as is security, using persistent storage 160, which removes the need to continually re-authenticate and re-expose one's private key. For example, the request processing system determines that a user has chosen a payment method to be a blockchain payment (e.g., making a selection using user interface element 230). The request processing system determines that the user, from various payment tool options, has selected an option corresponding to the blockchain payment tool. The user's browser may then load an interface (via UI element 230) to request authorization that can persist for a user-specified duration of time. After the user provides the authorization signature (e.g., uses their private key to sign a client-signed code packet), the authorization signature is stored in storage 160 for a client until revoked after the user-specified duration of time expires.

In this way, persistent authorization can enable a cryptocurrency transaction to ensue in partitions over time until the cryptocurrency transaction is complete. As an example, despite a user using a newly set up device (e.g., that has not yet been used to communicate with the request processing system), the request processing system can still authenticate the user without the user's involvement. The user can navigate to a client's website, provide their login credentials to the client, who can then confirm that the user has previously approved persistent storage of their authorization signature with the request processing system. The client may transmit a flag to the user's browser confirming the user's approval of persistent storage, and an outer Iframe on the user's browser may determine, using the flag, to query persistent authorization storage 160 for the stored client URL and user's authorization signature (e.g., using the user's blockchain wallet address or on-chain public key). In response to determining that the information is not found in storage 160 (e.g., a user-specified period of time has expired), the request processing system may prompt the user via UI element 230 to re-authenticate. In this manner, the user does not need to re-authenticate with the same client when changing devices, improving computational efficiency and security.

### Processes Using Decentralized Request System

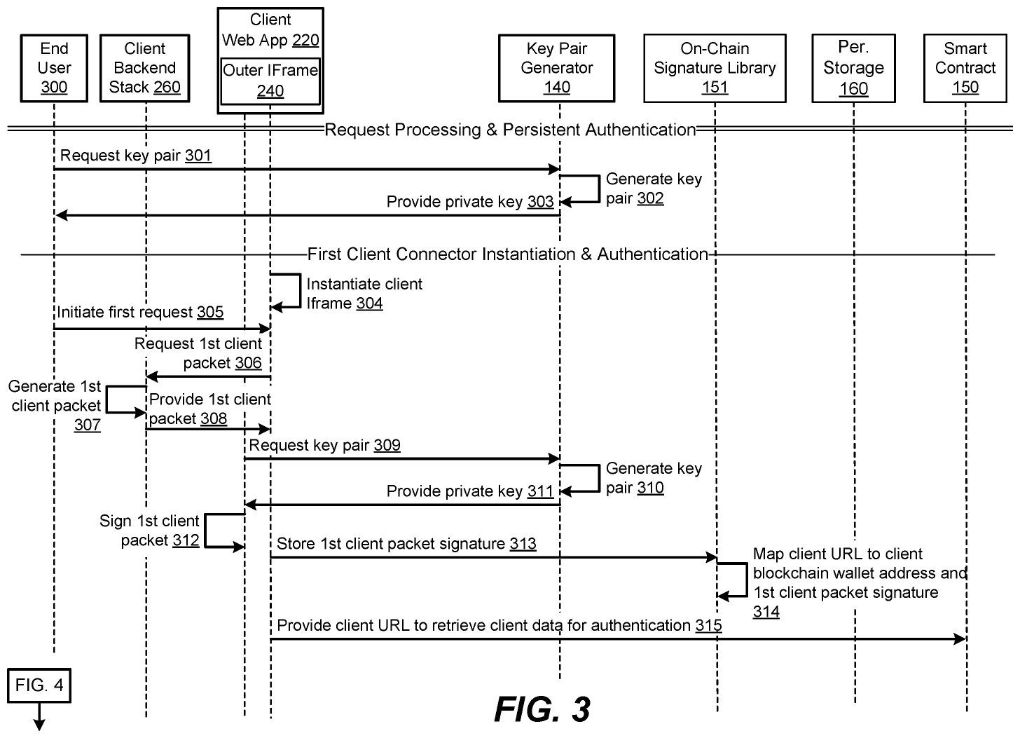

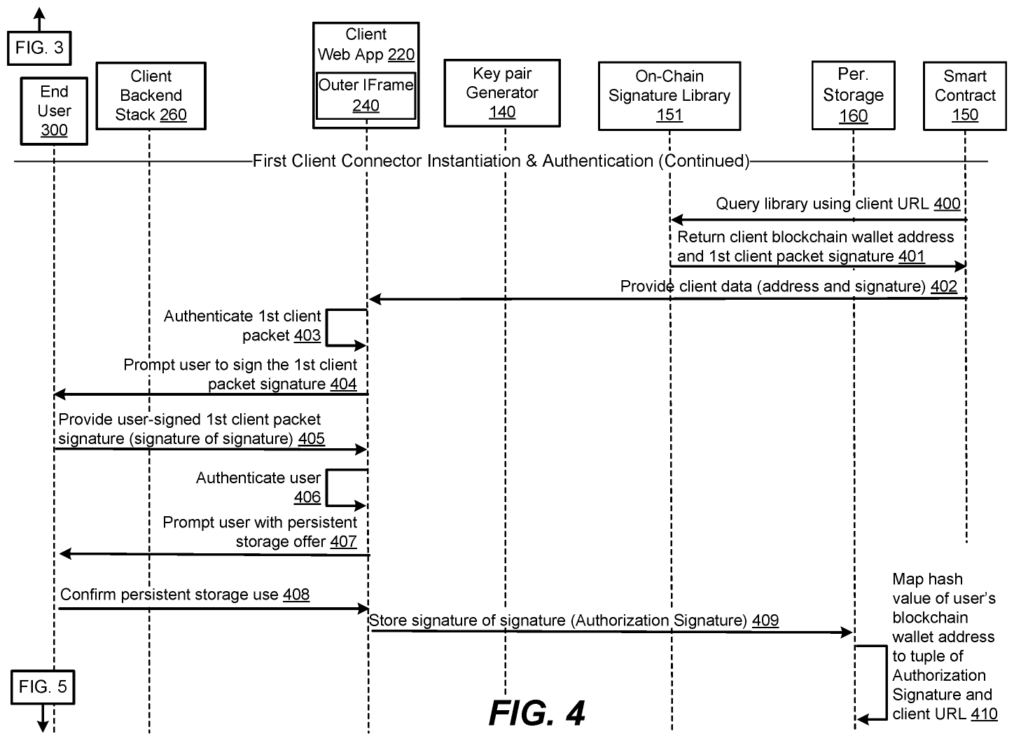

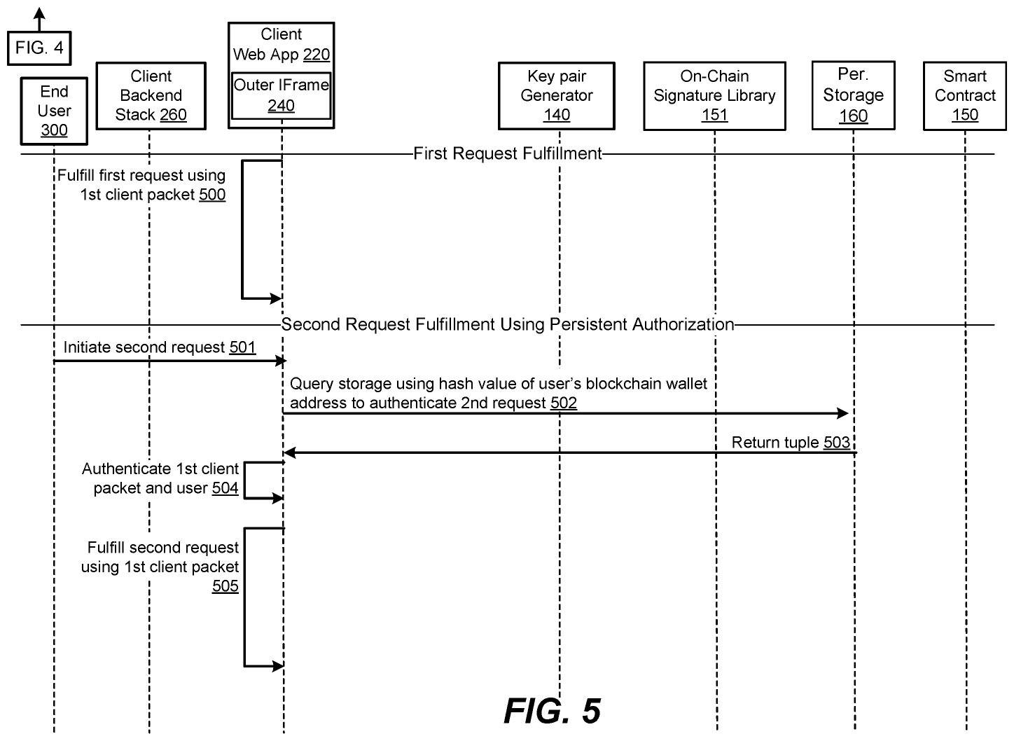

FIGS. 3-5 form an interaction diagram showing interactions between various entities for processing requests using persistent authentication, in accordance with one embodiment. End user 300 interacts with client web app 220 to fulfill a request (e.g., make a payment using their blockchain wallet) using persistent authentication, which is enabled using persistent storage 160. In some embodiments, the interactions illustrated in FIGS. 3-5 involve additional, fewer, or different functions or entities for performing the functions.

Before initiating requests with client web app 220, a cryptographic key pair is assigned to end user 300. End user 300 requests 301 a key pair from key pair generator 140. Key pair generator 140 generates 302 a key pair and provides 303 the private key of that key pair to end user 300. Although key pair generator 140 is shown in FIGS. 3-5 as generating key pairs for both end user 300 and clients, the key pairs may be generated from different sources. To instantiate and authenticate a first client connector, a client may integrate outer Iframe 240 (e.g., using an NPM package manager) into their front end interface, client web app 200. Outer Iframe 240 instantiates 304 a client connector in a client Iframe within outer Iframe 240. Outer Iframe 240 then initiates 304 a client Iframe that is configured to contain a client connector code packet for processing user requests. End user 300 initiates 305 a first request. For example, client web app 220 is an online merchant's web application and end user 300 has requested to purchase goods from via web app 220 with their blockchain wallet. Client web app 220 receives the user's request and outer Iframe 240 requests 306 a first client code packet to process the blockchain transaction. The request is sent to client backend stack 260, which generates 307 a first client code packet and provides 308 the first code packet to outer Iframe 240, which can load the first client code packet into the previously instantiated client Iframe.

To prevent abuse of client code packets for making fraudulent requests against the user's blockchain wallet, outer Iframe 240 increases the security of the first client code packet using a cryptographic signature of the client. Outer Iframe 240 requests 309 a cryptographic key pair from key pair generator 140, which generates 310 a key pair and provides 311 the private key of the key pair to the client. The client signs 312 the first client code packet using their private key, and outer Iframe 240 receives the signed first client code packet. Outer Iframe 240 stores 313 the signed first client code packet in on-chain signature library 151 in a way that the signed packet and the client's blockchain wallet address is mapped 314 to the client's URL (e.g., the merchant's website address). This mapping in library 151 is then used to authenticate future client code packets as coming from a trusted client that has verified their identity using their private key.

To continue fulfilling the user's first request, outer Iframe 240 provides 315 the client's URL to smart contract 150 to retrieve client data to authenticate the first code packet that is used to fulfill the user's first request. Upon receiving the client's URL, smart contract 150 is triggered to query 400 on-chain signature library 151 using the client's URL. Library 151 returns 401 client data stored in on-chain signature library 151. The client data includes the client blockchain wallet address and signature of the first client code packet that was previously stored into library 151. Smart contract 150 provides 402 the client data to outer Iframe 240, which authenticates 403 the first client code packet. Outer Iframe 240 prompts 404 the user to sign the first client code packet that has already been signed by the client's private key. For example, the request processing system described herein may generate a UI element for display at a user's computing device that prompts them to sign the signed packet using their private key. End user 300 provides 405 the signed first client packet that has previously been signed using the client's private key, providing a signature of a signature to outer Iframe 240. Outer Iframe 240 can then verify the signature of the signature to authenticate 406 the user (e.g., using the end user's public key).

Outer Iframe 240 prompts 407 end user 300 (e.g., via a UI element displayed in a browser context on the user's computing device) with an offer to store their authorization signature (the signature of the client's signature on the first client code packet) in persistent authorization storage 160. The prompt may also include user input elements for indicating conditions under which the authorization signature can be stored (e.g., until five requests are subsequently made with the client packet, until twenty four hours passes, etc.). In response to end user 300 confirming 408 that they approve of the persistent storage, outer Iframe 240 stores 409 the authorization signature into storage 160, where a tuple of the authorization signature and client URL are mapped 410 to a hashed value of the user's blockchain wallet address (or any suitable identifier of the user such as a user's public key). In some embodiments, the user may persistently store multiple authorization signatures (e.g., authorization signature for respective merchants' code packets), where each authorization signature is mapped to a different, user identifier (e.g., one is mapped to the hashed value of the user's blockchain wallet and another is mapped to the user's public key).

Outer Iframe 240 fulfills 500 the first request of end user 300 using the first client code packet. Outer Iframe 240 can then fulfill a subsequent request from end user 300 directed to client web app 220 (or another client web app of the client that is integrated with the request processing system and its the nested Iframe architecture). Outer Iframe 240 receives a second request that is initiated 501 by end user 300. Because the user has previously approved of persistent authorization storage with the client (e.g., through client web app 220), client web app 220 can use outer Iframe 240 to query 502 persistent authorization storage 160 using a hash value of the user's blockchain wallet address to retrieve the stored authorization signature and client URL to authenticate both the client and the user for the second request. The first client code packet is used to fulfill the second request after outer Iframe 240 has finished using it to fulfill the first request. The information retrieved from persistent storage 160 can be used to authenticate the client and the first code packet. Persistent storage 160 returns 503 the tuple containing the authorization signature and client URL, which outer Iframe 240 uses to authenticate 504 the first client packet and end user 300. After authenticating 504, outer Iframe 240 fulfills 505 the second request using the first client code packet.

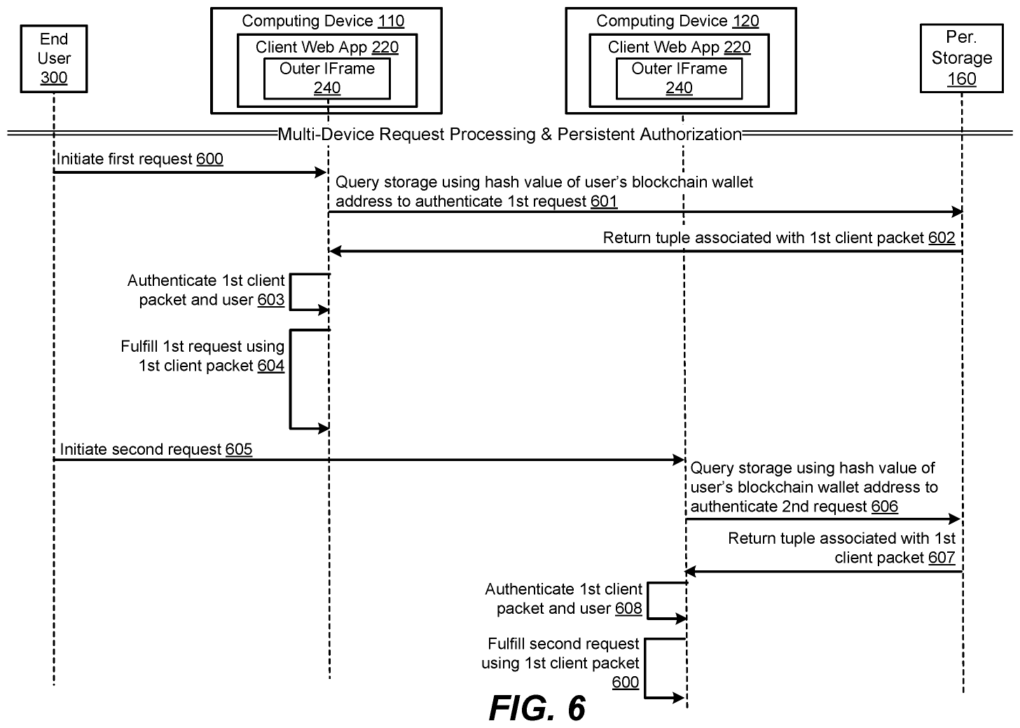

FIG. 6 is an interaction diagram showing interactions between various entities for processing requests across multiple devices using persistent authentication, in accordance with one embodiment. End user 300 interacts with client web app 220 that is instantiated on two different computing devices 110 and 120 to fulfill multiple requests (e.g., make a payment using their blockchain wallet) using persistent authentication, which is enabled using persistent storage 160. In some embodiments, the interactions illustrated in FIG. 6 involves additional, fewer, or different functions or entities for performing the functions.

End user 300 initiates 600 a first request. For example, end user 300 interacts with a UI element of client web app 220 on their computing device 110 to request to purchase goods with the merchant associated with client web app 220. Outer Iframe 240 on device 110 can receive the user's request and a flag from the client indicating that the user has previously approved persistent storage of their authorization signature. Outer Iframe 240 on device 110 then queries 601 persistent authorization storage 160 using a hash value of a user's blockchain wallet address to authenticate the user and the client code packet assigned by outer Iframe 240 to process the first request. Persistent storage 160 returns 602 the tuple associated with the first client code packet (e.g., containing the user's signature of the first client code packet signed by the client's private key). Outer Iframe 240 authenticates 603 the first client packet and end user 300. Outer Iframe 240 fulfills 604 the first request using the authenticated first client code packet.

End user 300 may switch to computing device 120 to initiate 605 a second request. The client web app 220 instantiated on computing device 120 determines that the user has previously approved of persistent storage and provides a flag to outer Iframe 240 on computing device 120. Outer Iframe 240 on computing device 120 then queries 606 storage using a hashed value of the user's blockchain wallet address to authenticate the second request. Persistent storage returns 607 the same tuple that was previously returned 602 to outer Iframe 240 instantiated on computing device 110. Outer Iframe 240 on computing device 120 can then authenticate 608 the first client code packet and the user to fulfill 609 the second request using the authenticated first client code packet. FIG. 6 demonstrates how the request processing system can persistently store the signature of the user in connection with the information of a client (e.g., a merchant) and maintain authorization of the merchant to debit cryptocurrency from the user without further authorization involving the user.

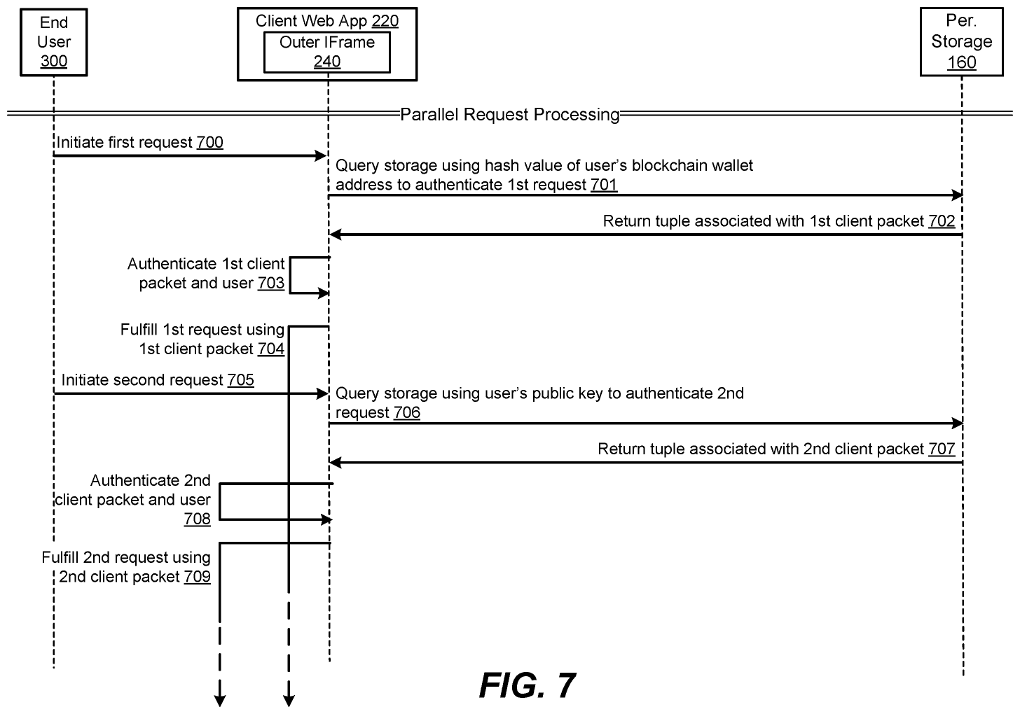

FIG. 7 is an interaction diagram showing interactions between various entities for processing requests in parallel with a single client, in accordance with one embodiment. End user 300 interacts with client web app 220 to fulfill multiple requests (e.g., make a payment using their blockchain wallet) using persistent authentication, which is enabled using persistent storage 160. In some embodiments, the interactions illustrated in FIG. 7 involves additional, fewer, or different functions or entities for performing the functions.

End user 300 initiates 700 a first request to client web app 220. Client web app 220 determines that the user has previously approved persistent storage of their authorization signature. Accordingly outer Iframe 240 queries persistent authorization storage 160 using hash values of the end user's blockchain wallet address to authenticate first request (e.g., by authenticating the user and the first client code packet assigned to process the first request). Persistent storage 160 returns a tuple associated with the first client packet 702 (e.g., the tuple containing the client URL and the end user's authorization signature associated with the first client code packet). After receiving the tuple, outer Iframe 240 authenticates 703 the first client code packet and end user 300. Outer Iframe 240 fulfills 704 the first request using the authenticated first client code packet. While fulfilling 704 the first request, outer Iframe 240 receives a second request initiated 705 by end user 300. Outer Iframe 240 assigns a second client code packet to fulfill the user's second request and queries 706 persistent storage 160 for the persistent authorization that was stored for the second client code packet. For example, the authorization signature and client URL form a tuple that is mapped to the user's public key. Persistent authorization storage 160 returns 707 a tuple associated with the second client code packet. Outer Iframe 240 authenticates 708 the second client code packet and end user 300 using the returned tuple. Outer Iframe 240 fulfills 709 the second request using the authenticated second packet.

FIG. 8 is an interaction diagram showing interactions between various entities for preventing malicious actors from making fraudulent requests against an end user's account (e.g., blockchain wallet), in accordance with one embodiment. End user 300 interacts with client web app 220 to initiate a request and malicious actor 800 intercepts an authenticated client code packet generated to fulfill the user's request (e.g., make a payment using their blockchain wallet). In some embodiments, the interactions illustrated in FIG. 8 involves additional, fewer, or different functions or entities for performing the functions.

End user 300 initiates 801 a first request directed to client web app 220. Outer Iframe 240 may instantiate a client connector and request 802, from client backend stack 260, a client code packet to load in the client connector. Client backend stack 260 generates 803 the client code packet and provides 804 the generated client code packet to outer Iframe 240. The client uses their private key to sign 805 the client packet. Outer Iframe 240 stores 806 the signature of the first client code packet at on-chain signature library 151, where the signature is mapped 807 with the client blockchain wallet address to the client's URL. Malicious actor 800 attacks the vulnerable browser context in which Outer Iframe 240 is instantiated and intercepts 808 the authenticated client packet. As a consequence of this interception, outer Iframe 240 loads 809 a fraudulent packet for processing a request from malicious actor 800. Outer Iframe 240 follows procedure for fulfilling a user's request, which includes authenticating the client code packet. To begin the process for authenticating the client code packet, outer Iframe 240 provides 810 the client URL to retrieve client data for authentication. Smart contract 150 queries 811 on-chain signature library 151 using the client URL. Library 151 returns 812 the client blockchain wallet address and client packet signature previously stored 806. Smart contract provides 813 the address and signature to outer Iframe 240, which determines 814 that the fraudulent code packet and provided 813 signature does not map to the provided 813 address and consequently, rejects the request from malicious actor 800.

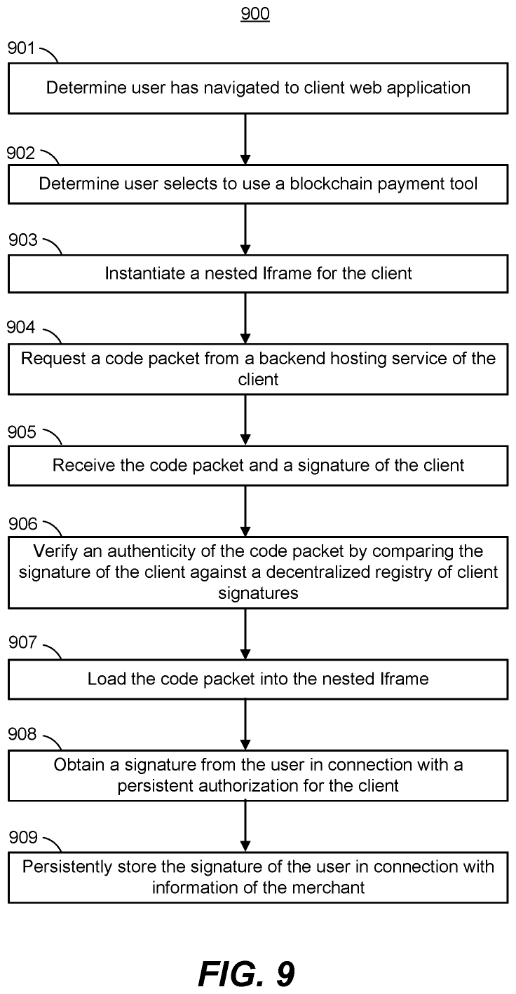

FIG. 9 is a flowchart depicting process 900 for instantiating a code packet used to fulfill a user's request (e.g., processing a transaction against their blockchain wallet) and persistently store data authenticating the user for future requests, in accordance with one embodiment. The request processing system may include a user interface element (e.g., user interface element 230) and an outer Iframe (e.g., outer Iframe 240). The request processing system described herein may perform process 900. In some embodiments, the system performs operations of process 900 in parallel or in different orders, or may perform different steps.

The request processing system determines 901 a user has navigated to a client web application. For example, the system makes this determination 901 in response to determining that user interface element 230 has been rendered on the client web application at an Internet browser (e.g., after the user has visited the URL of the client). User interface element 230 may include a dropdown menu of selectable payment methods, including an option to use a blockchain payment tool or any suitable cryptocurrency payment tool. In response to a user interacting with the dropdown menu of user interface element 230, the system determines 902 that the user has selected to use the blockchain payment tool.

The request processing system instantiates 903 a nested Iframe for the client. For example, the system instantiates 903 client Iframe 221 within outer Iframe 240, where client Iframe 221 is assigned to the client for processing blockchain payments for the client. The system requests 904 a code packet from a backend hosting service of the client. For example, the system requests 904 a code packet, from client backend stack 260, to load into client connector 222. The system receives 905 the code packet and a signature from the client, where the signature is the code packet signed using the private key of the client.

The request processing system verifies 906 an authenticity of the code packet by comparing the signature of the client against a decentralized registry of client signatures. In circumstances where the authenticate code packet is intercepted by a malicious actor, as described in FIG. 8, the code packet may be a fraudulent packet and verification against the registry of authenticated client signatures will reveal the fraud. In the embodiment described in FIG. 9, the code packet has not been intercepted and the system is able to verify 906 its authenticity. The system loads 907 the authenticated code packet into the nested Iframe after verifying its authenticity. In some embodiments, the system can remove code packets that are determined to be inauthentic after an attempt at verification. In these embodiments, the code packet may be loaded into the nested Iframe prior to verification and subsequently removed if determined to be inauthentic.

The request processing system obtains 908 a signature from the user in connection with a persistent authorization for the client. For example, user interface element 230 displays a prompt at the user's computing device offering persistent storage of the user's signature on the authenticated code packet. If the user accepts the offer, the system persistently stores 909 this authorization signature (e.g., in persistent authorization storage 160). Example processes for utilizing persistent storage to improve the user's experience and increase security are shown in FIGS. 3-7.

### Computing Machine Architecture

FIG. 10 is a block diagram illustrating components of an example machine able to read instructions from a machine-readable medium and execute them in a processor (or controller). Specifically, FIG. 10 shows a diagrammatic representation of a machine in the example form of a computer system 1000 within which program code (e.g., software) for causing the machine to perform any one or more of the methodologies discussed herein may be executed. The program code may be comprised of instructions 1024 executable by one or more processors 1002. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 1000 includes a processor 1002 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1004, and a static memory 1006, which are configured to communicate with each other via a bus 1008. The computer system 1000 may further include visual display interface 1010. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 1010 may include or may interface with a touch enabled screen. The computer system 1000 may also include alphanumeric input device 1012 (e.g., a keyboard or touch screen keyboard), a cursor control device 1014 (e.g., a mouse, a trackball, a joystick, a motion sensor, or other pointing instrument), a storage unit 1016, a signal generation device 1018 (e.g., a speaker), and a network interface device 1020, which also are configured to communicate via the bus 1008.

The storage unit 1016 includes a machine-readable medium 1022 on which is stored instructions 1024 (e.g., software) embodying any one or more of the methodologies or functions described herein. The instructions 1024 (e.g., software) may also reside, completely or at least partially, within the main memory 1004 or within the processor 1002 (e.g., within a processor's cache memory) during execution thereof by the computer system 1000, the main memory 1004 and the processor 1002 also constituting machine-readable media. The instructions 1024 (e.g., software) may be transmitted or received over a network 1026 via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store instructions (e.g., instructions 1024). The term “machine-readable medium” shall also be taken to include any medium that is capable of storing instructions (e.g., instructions 1024) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules.

A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for implementing a secure merchant connector through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
determining that a user has navigated to a merchant web app;
determining that the user selects to use a blockchain payment tool;
instantiating a nested Iframe for the merchant, the nested Iframe among a plurality of Iframes for different merchants, the plurality of Iframes being within an external Iframe;
requesting a code packet from a backend hosting service of the merchant;
receiving the code packet and a signature of the merchant;
verifying an authenticity of the code packet by comparing the signature of the merchant against a decentralized registry of merchant signatures;
loading the code packet into the nested Iframe;
obtaining a signature from the user in connection with a persistent authorization for the merchant; and
persistently storing the signature of the user in connection with information of the merchant, wherein during future interactions between the user and the merchant web app, payments are processed using the persistently stored signature of the user.

2. The method of claim 1, wherein determining that the user selects to use a blockchain payment tool comprises determining that the user, from a plurality of payment tool options, has selected an option corresponding to the blockchain payment tool.

3. The method of claim 1, wherein the decentralized registry of merchant signatures is curated using a decentralized governance mechanism.

4. The method of claim 3, wherein the decentralized governance mechanism is a blockchain mechanism that ensures the merchant signatures cannot be tampered with.

5. The method of claim 1, wherein the persistent authorization enables a cryptocurrency transaction to ensue in partitions over time until the cryptocurrency transaction is complete.

6. The method of claim 1, wherein the plurality of nested Iframes are configured to process payments for multiple merchants simultaneously.

7. The method of claim 1, wherein the nested Iframe is instantiated within an insecure browser environment, and wherein code operated within the nested Iframe is secure.

8. The method of claim 1, wherein the decentralized registry comprises, for each merchant registered within the decentralized registry, a data structure that maps a merchant uniform resource locator (URL) to a blockchain wallet address of the merchant and a cryptographic signature of a code packet corresponding to the merchant.

9. The method of claim 8, wherein persistently storing the signature of the user in connection with information of the merchant comprises persistently storing the merchant URL and the blockchain wallet address of the merchant for retrieval during future web sessions, wherein persistently storing the signature of the user in connection with the information of the merchant maintains authorization of the merchant to debit cryptocurrency from the user without further authorization.

10. A non-transitory computer-readable medium comprising memory with instructions encoded thereon, the instructions, when executed, causing one or more processors to perform operations, the instructions comprising instructions to:
determine that a user has navigated to a merchant web app;
determine that the user selects to use a blockchain payment tool;
instantiate a nested Iframe for the merchant, the nested Iframe among a plurality of Iframes for different merchants, the plurality of Iframes being within an external Iframe;
request a code packet from a backend hosting service of the merchant;
receive the code packet and a signature of the merchant;
verify an authenticity of the code packet by comparing the signature of the merchant against a decentralized registry of merchant signatures;
load the code packet into the nested Iframe;
obtain a signature from the user in connection with a persistent authorization for the merchant; and
persistently store the signature of the user in connection with information of the merchant, wherein during future interactions between the user and the merchant web app, payments are processed using the persistently stored signature of the user.

11. The non-transitory computer-readable medium of claim 10, wherein the instructions to determine that the user selects to use a blockchain payment tool further comprise instructions to:
determine that the user, from a plurality of payment tool options, has selected an option corresponding to the blockchain payment tool.

12. The non-transitory computer-readable medium of claim 10, wherein the decentralized registry of merchant signatures is curated using a decentralized governance mechanism.

13. The non-transitory computer-readable medium of claim 12, wherein the decentralized governance mechanism is a blockchain mechanism that ensures the merchant signatures cannot be tampered with.

14. The non-transitory computer-readable medium of claim 10, wherein the persistent authorization enables a cryptocurrency transaction to ensue in partitions over time until the cryptocurrency transaction is complete.

15. The non-transitory computer-readable medium of claim 10, wherein the plurality of nested Iframes are configured to process payments for multiple merchants simultaneously.

16. A system comprising:
memory with instructions encoded thereon; and
one or more processors that, when executing the instructions, are caused to perform operations comprising:
determining that a user has navigated to a merchant web app;
determining that the user selects to use a blockchain payment tool;
instantiating a nested Iframe for the merchant, the nested Iframe among a plurality of Iframes for different merchants, the plurality of Iframes being within an external Iframe;
requesting a code packet from a backend hosting service of the merchant;
receiving the code packet and a signature of the merchant;
verifying an authenticity of the code packet by comparing the signature of the merchant against a decentralized registry of merchant signatures;
loading the code packet into the nested Iframe;
obtaining a signature from the user in connection with a persistent authorization for the merchant; and
persistently storing the signature of the user in connection with information of the merchant, wherein during future interactions between the user and the merchant web app, payments are processed using the persistently stored signature of the user.

17. The system of claim 16, wherein determining that the user selects to use a blockchain payment tool comprises determining that the user, from a plurality of payment tool options, has selected an option corresponding to the blockchain payment tool.

18. The system of claim 16, wherein the decentralized registry of merchant signatures is curated using a decentralized governance mechanism.

19. The system of claim 18, wherein the decentralized governance mechanism is a blockchain mechanism that ensures the merchant signatures cannot be tampered with.

20. The system of claim 16, wherein the persistent authorization enables a cryptocurrency transaction to ensue in partitions over time until the cryptocurrency transaction is complete.
